(19) United States
(12) Patent Application Publication
(10) Pub. No.: US 2021/0289749 A1
(43) Pub. Date: Sep. 23, 2021

(54) Dog Chew

(71) Applicant: Shyh-Jen Lai, New Taipei City (TW)

(72) Inventor: Shyh-Jen Lai, New Taipei City (TW)

(21) Appl. No.: 16/822,477

(22) Filed: Mar. 18, 2020

(51) Int. Cl. A01K 15/02

(52) U.S. Cl. CPC A01K 15/026

(57) ABSTRACT

A dog chew is stiff and is made of plastic material, and the dog chew contains: a first body, a second body, and a connection member. The first body is separately connected with the second body by ways of the connection member so as to define a first groove and a second groove among the first body, the connection member, and the second body. Each of the first body and the second body includes multiple pillars extending outward therefrom, and the multiple pillars are separated from one another. Each of the first groove and the second groove includes multiple pegs extending outward therefrom, and the multiple pegs are separated from one another. Each of the multiple pillars and the multiple pegs is formed in a sharp cone or a sharp column shape.

### FIELD OF THE INVENTION

The present invention relates to a dog chew which is stiff and is made of plastic material so as to clean a dog's teeth by ways of multiple pillars and pegs.

### BACKGROUND OF THE INVENTION

A conventional edible toothpick is applied to train a dog to bite, grind and clean teeth. The conventional non-edible dog chew is winded or tied by a rope so that the dog bits and cleans teeth, and the convention non-edible dog chew has multiple recesses, protrusions, or bosses, thus grinding and cleaning the dog's teeth.

However, the multiple protrusions and bosses of the conventional non-edible dog chew are formed radially outward, so they only clean inner surfaces of the dog's teeth and brushing outer surfaces of the dog's teeth has to be manually done by a dog's owner with a tooth brush.

Furthermore, the dog swallows the dog chew into esophagus easily, thus causing using danger.

The present invention has arisen to mitigate and/or obviate the afore-described disadvantages.

### SUMMARY OF THE INVENTION

The primary aspect of the present invention is to provide a dog chew which is stiff and is made of plastic material so as to clean a dog's teeth by ways of multiple pillars and pegs.

Another aspect of the present invention is to provide a dog chew which contains a rope tied on bottoms of the first groove and the second groove, and the rope has an anti-swallow protrusion extending from a distal end thereof so that the dog chew is pulled out of esophagus and oral cavity of the dog after being swallowed, thus obtaining using safety.

To obtain above-mentioned aspects, a dog chew provided by the present invention is stiff and is made of plastic material, and the dog chew contains: a first body, a second body, and a connection member.

The first body is separately connected with the second body by ways of the connection member so as to define a first groove and a second groove among the first body, the connection member, and the second body. Each of the first body and the second body includes multiple pillars extending outward therefrom, and the multiple pillars are separated from one another. Each of the first groove and the second groove includes multiple pegs extending outward therefrom, and the multiple pegs are separated from one another. Each of the multiple pillars and the multiple pegs is formed in a sharp cone or a sharp column shape.

Preferably, the connection member includes a first recessed portion formed on a first end thereof, and the connection member includes a second recessed portion arranged on a second end thereof, such that a rope is tied on bottoms of the first groove and the second groove, and the rope has an anti-swallow protrusion extending from a distal end thereof.

Preferably, the first body includes a first extension and two first head segments connected with two ends of the first extensions respectively.

Preferably, the second body includes a second extension and two second head segments connected with two ends of the second extension respectively, wherein the second extension corresponds to the first extension, and a respective one of the two second head segments corresponds to a respective one of the two first head segments.

Preferably, each of the multiple pillars and the multiple pegs is formed in a sharp cone or a sharp column shape.

Preferably, a respective one of the multiple first head segment is semicircular.

Preferably, a respective one of the multiple second head segment is semicircular.

Preferably, a cross section of a connection portion of the first extension, the connection member, and the second extension is formed in an H shape.

### BRIEF DESCRIPTION OF THE DRAWINGS

FIG. 1 is a perspective view showing the exploded components of a dog chew according to a preferred embodiment of the present invention.

FIG. 2 is a perspective vies showing the assembly of the dog chew according to the preferred embodiment of the present invention.

FIG. 3 is cross sectional view taken along the line A-A of FIG. 2.

FIG. 4 is cross sectional view taken along the line B-B of FIG. 2.

FIG. 5 is a cross sectional view showing the assembly of the dog chew according to the preferred embodiment of the present invention.

### DETAILED DESCRIPTION OF THE PREFERRED EMBODIMENTS

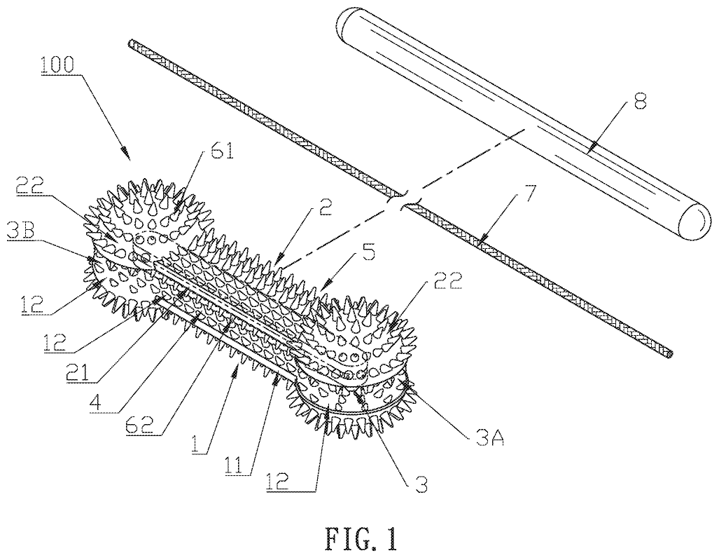

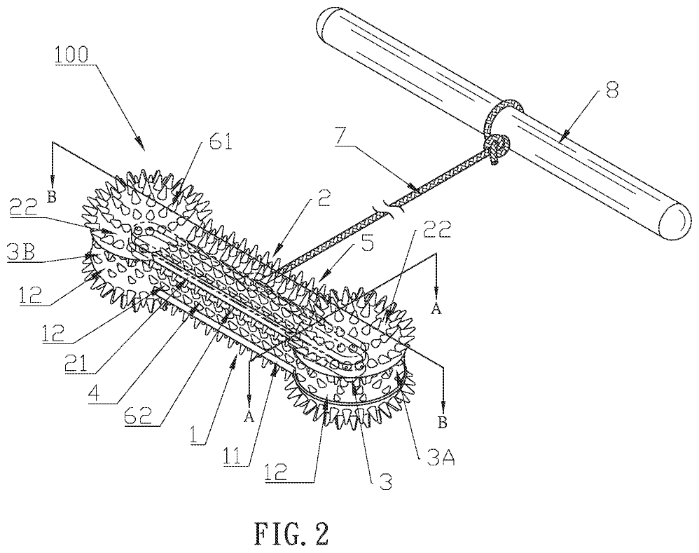

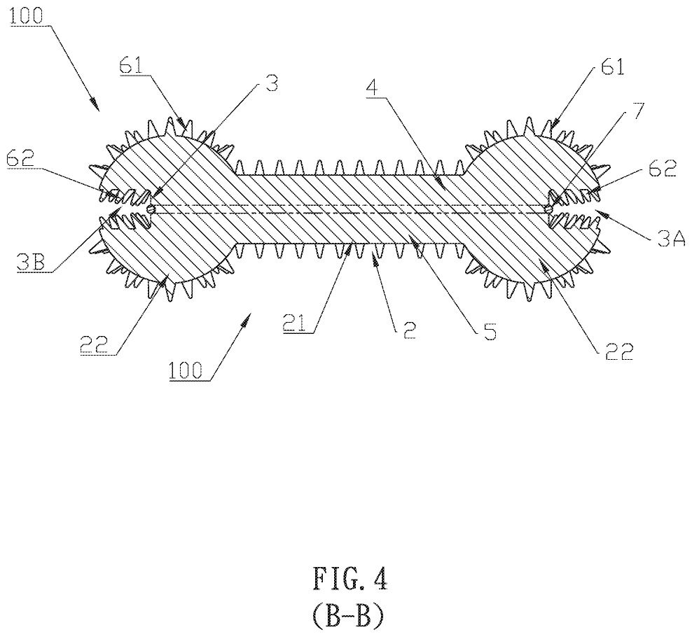

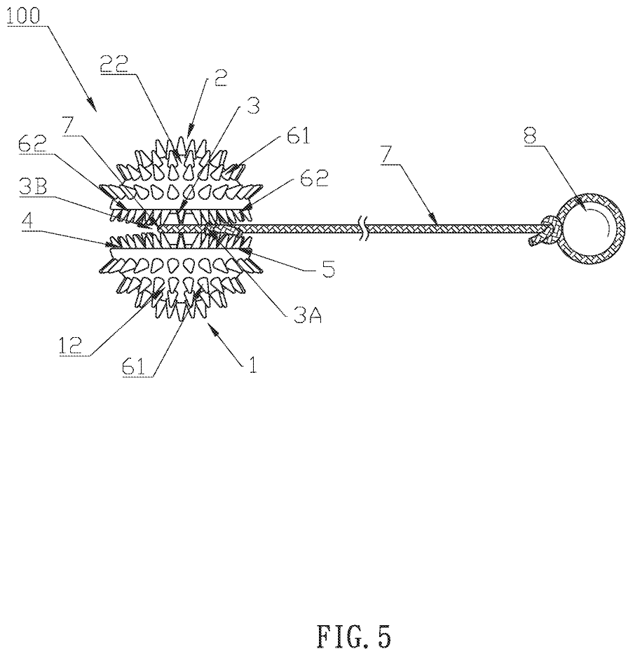

With reference to FIGS. 1-5, a dog chew 100 according to a preferred embodiment of the present invention is stiff and is made of plastic material. The dog chew 100 comprises: a first body 1, a second body 2, and a connection member 3.

The first body 1 is separately connected with the second body 2 by ways of the connection member 2 so as to define a first groove 4 and a second groove 5 among the first body 1, the connection member 3, and the second body 2.

The first body 1 includes a first extension 11 and two first head segments 12 connected with two ends of the first extensions 11 respectively. The second body 2 includes a second extension 21 and two second head segments 22 connected with two ends of the second extension 21 respectively, wherein the second extension 21 corresponds to the first extension 11, and a respective one of the two second head segments 22 corresponds to a respective one of the two first head segments 12.

A cross section of a connection portion of the first extension 11, the connection member 3, and the second extension 21 is formed in an H shape.

The respective one first head segment 12 is semicircular, and the respective one second head segment 22 is semicircular. Preferably, the dog chew 100 is formed in a bone shape so that a dog bites the dog chew 100.

Each of the first body 1 and the second body 2 includes multiple pillars 61 extending outward therefrom, and the multiple pillars 61 are separated from one another. Each of the first groove 4 and the second groove 5 includes multiple pegs 62 extending outward therefrom, and the multiple pegs 62 are separated from one another. Each of the multiple pillars 61 and the multiple pegs 62 is formed in a sharp cone or a sharp column shape.

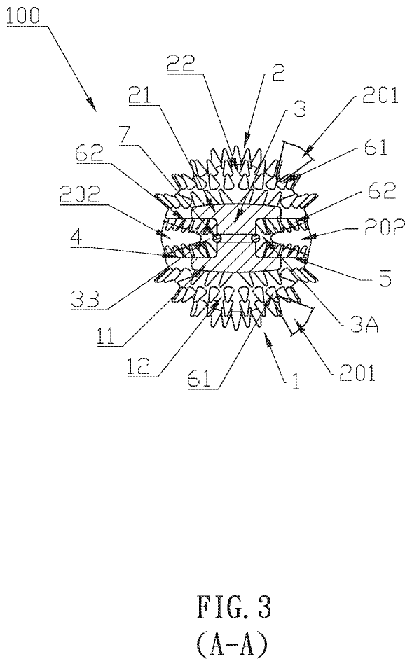

The first groove 4 and the second groove 5 are defined among the first body 1, the third connection member 3, and the second body 2 so that the cross section of the connection portion of the first extension 11, the connection member 3, and the second extension 21 is formed in the H shape. A dog bites the multiple pillars 61 of the first body 1 and the second body 2 with first teeth 201, thus cleaning the first teeth, as shown in an upper portion and a lower portion of FIG. 3.

Preferably, each of the first groove 4 and the second groove 5 includes the multiple pegs 62 extending outward therefrom, so the dog bites the multiple pegs 62 with second teeth 202, thus cleaning the second teeth, as illustrated in a left portion and a right portion of FIG. 3.

The connection member 3 includes a first recessed portion 3A formed on a first end thereof, and the connection member 3 includes a second recessed portion 3B arranged on a second end thereof, such that a rope 7 is tied on bottoms of the first groove 4 and the second groove 5, and the rope 7 has an anti-swallow protrusion 8 extending from a distal end thereof so that the dog chew 100 is pulled out of esophagus and oral cavity of the dog after being swallowed, thus obtaining using safety.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A dog chew being stiff and being made of plastic material, the dog chew comprising: a first body, a second body, and a connection member;
The first body being separately connected with the second body by ways of the connection member so as to define a first groove and a second groove among the first body, the connection member, and the second body;
wherein each of the first body and the second body includes multiple pillars extending outward therefrom, and the multiple pillars are separated from one another;
wherein each of the first groove and the second groove includes multiple pegs extending outward therefrom, and the multiple pegs are separated from one another;
wherein each of the multiple pillars and the multiple pegs is formed in a sharp cone or a sharp column shape.

2. The dog chew as claimed in claim 1, wherein the connection member includes a first recessed portion formed on a first end thereof, and the connection member includes a second recessed portion arranged on a second end thereof, such that a rope is tied on bottoms of the first groove and the second groove, and the rope has an anti-swallow protrusion extending from a distal end thereof.

3. The dog chew as claimed in claim 1, wherein the first body includes a first extension and two first head segments connected with two ends of the first extensions respectively.

4. The dog chew as claimed in claim 2, wherein the second body includes a second extension and two second head segments connected with two ends of the second extension respectively, wherein the second extension corresponds to the first extension, and a respective one of the two second head segments corresponds to a respective one of the two first head segments.

5. The dog chew as claimed in claim 1, wherein each of the multiple pillars and the multiple pegs is formed in a sharp cone or a sharp column shape.

6. The dog chew as claimed in claim 2, wherein a respective one of the multiple first head segment is semicircular.

7. The dog chew as claimed in claim 3, wherein a respective one of the multiple second head segment is semicircular.

8. The dog chew as claimed in claim 3, wherein a cross section of a connection portion of the first extension, the connection member, and the second extension is formed in an H shape.
